(19) United States
(12) Patent Application Publication
(10) Pub. No.: US 2015/0183067 A1
(43) Pub. Date: Jul. 2, 2015

(54) Apparatus and Method for Providing a Friction Surface on a Substantially Cylindrical Object

(71) Applicant: Lesley Ruskaup, Thornton, CO (US)

(72) Inventor: Lesley Ruskaup, Thornton, CO (US)

(21) Appl. No.: 14/584,490

(22) Filed: Dec. 29, 2014

Related U.S. Application Data
(60) Provisional application No. 61/922,747, filed on Dec. 31, 2013.

(51) Int. Cl. B23P 17/00

(52) U.S. Cl. CPC B23P 17/00

(57) ABSTRACT

Embodiments of an apparatus and a method for providing a friction surface on a substantially cylindrical object are disclosed. The apparatus includes a base and a fastening system. The base is made of bendable material and has a first surface, a second surface, a first end, and a second end. The first end and the second end are on opposite sides of the base along a longitudinal axis of the base. The base is of a sufficient length to wrap around at least a portion of a surface of a substantially cylindrical object. A portion of the second surface is a friction material that holds the base in place when the base is affixed to the substantially cylindrical object with the second surface in contract with the surface of the substantially cylindrical object. The fastening system connects to the base to hold the base in place in response to the base being wrapped around at least a portion of the surface of the substantially cylindrical object.

### CROSS-REFERENCE TO RELATED APPLICATIONS

The current application claims priority to U.S. Provisional Patent Application No. 61/922,747, filed Dec. 31 2013, the disclosure of which is incorporated herein by reference in its entirety as if set forth herewith.

### FIELD OF THE INVENTION

This invention relates to providing a friction surface on a surface. More particularly, this invention relates to providing a friction surface on a substantially cylindrical surface. More particularly, this invention relates to an apparatus for providing a friction surface on a metallic pole to attach accessories for use in exercise and dance routines.

### BACKGROUND OF THE INVENTION

Many endeavors require the hanging of a cloth fabric or other material to an object and more particularly a substantially cylindrical object such as a pole. The objects, such as poles, are often made of a smooth surface that provides little if no friction to keep a material wrapped around the substantially cylindrical object in place. Consequently, the material tends to slip downwards on a substantially vertical pole.

One particular endeavor where the slippage of the material is pole-dancing. Pole-dancing has recently become a popular form of exercise. Some dance routines in a pole dancing work-out require the use of a fabric attached to the pole to hang from as the dance routine is performed. However, it is a problem that the material tends to slide down the smooth metallic poles often used in these workouts.

One previously tried solution includes using a girth hitch to attach a mountaineering sling to a threaded bolt located near the top of the pole and then threading the material through the sling. The problem with this solution is that movement of the mountaineering sling caused to sling to wear that may cause breakage. Further the movement of the sling could cause the bolt loosen which may in turn cause loss of support to the sling and/or cause structural problems with the stability of the pole.

Another previously tried solution included wrapping athletic tape or some other adhesive material around the pole and attaching a mountaineering sling directly to the pole over the tape. However, this often left a residue of adhesive material such as epoxy on the pole that was hard to remove and may interfere with other routines. As such, those skilled in the art strive for a better method of attaching material to a pole.

### SUMMARY OF THE INVENTION

The above described and other problems are solved and an advance in the art is made by a friction surface providing apparatus in accordance with embodiments of this invention. A first advantage of an apparatus in accordance with some embodiments of this invention is that the apparatus is easy to attach and remove. A second advantage of an apparatus in accordance with some embodiments of this invention is that the apparatus provides a friction surface for other materials wrapped around an object to prevent slippage of the material. A third advantage is of an apparatus in accordance with some embodiments of the invention is that the apparatus does not interact with structural components of the object reducing where to apparatus and not harming the structural integrity of the object.

In accordance with some embodiments of the invention, the apparatus includes a base and a fastening system. The base is made of bendable material and has a first surface, a second surface, a first end, and a second end. The first end and the second end are on opposite sides of the base along a longitudinal axis. Further, the base is of a sufficient length to wrap around at least a portion of a surface of an object. A portion of the second surface of the base includes a friction material that holds the base in place when the base is affixed to the object. The second surface is in contract with the surface of the object when the base is wrapped around the object. The fastening system engages the base to hold the base in place in response to the base being wrapped around at least a portion of the surface of the object.

In accordance with a number of embodiments of the invention, a portion of the first surface of the base includes a friction material to provide a friction surface to hold a secondary object wrapped around the apparatus and the base when the base is wrapped around the surface of the substantially cylindrical object.

In accordance with some embodiments of the invention, the portion of the second surface that is a friction material is two or more strips of friction material affixed to the second surface. In accordance with some of these embodiments, the two or more strips of friction material cover substantially a majority of the second surface.

In accordance with many embodiments of the invention the fastening system includes a hook and loop system. A first piece of a hook and loop system has a first end and a second end. The first piece is affixed to the first surface of the base on the first end of the base with the first end of the first piece being proximate to the first end of the base. A second piece of the hook and loop system is mated to the first piece of the system and has a first end and a second end. The first end of the second piece connects to the second end of the first piece as the second piece wraps around the base when the base is wrapped around the surface of the object. The second end affixes to the first end of the first piece as the second piece wraps around the base when the base is wrapped around the surface of the object.

In a number of embodiments, the fastening system includes multiple hook and loop systems. Each of the hook and loop systems include a first piece and a second piece. The first piece of a hook and loop system has a first end and a second end and is affixed to the first surface of the base on the first end of the base with the first end of the first piece being proximate to the first end of the base. The second piece of the hook and loop system is mated to the first piece and has a first end and a second end. The first end connects to the second end of the first piece as the second piece wraps around the base when the base is wrapped around the surface of the object. The second end affixes to the first end of the first piece as the second piece wraps around the base when the base is wrapped around the surface of the object. In accordance with several embodiments, the hook and loop systems include a first and second hook and loop system. The first piece of the first hook and loop system is affixed to the first surface of the base proximate a first side of the first end of the base and the first piece of the second hook and loop system is affixed to the first surface of the base proximate a second side of the first end of the base opposite the first side of the base.

In accordance with various embodiments, the fastening system includes at least one selected from a group consisting of: a belt with a buckle hole system that wraps around the first surface of the base, a belt with a loop system in which a first end of the belt threads through a plurality of loops as the belt wraps around the first surface of the base, and an elastic strap with hooks on opposing ends where the hooks are couple to hold the strap in place when the elastic strap wraps around the first surface of the base.

In accordance with some embodiments, the base is made of a friction material such that the first and second surfaces are the friction material. In accordance with some of these embodiments, the friction material of the base is rubber. In accordance with some embodiments, the object is a substantially cylindrical object. In some of these embodiments, the substantially cylindrical surface is a metallic pole.

In accordance with some embodiments of the invention, a method for affixing a base to provide a friction material on a surface of a substantially cylindrical object is performed in the following manner. A base is wrapped around the surface of the substantially cylindrical surface. The base has a first surface having a friction material on at least a portion of the first surface and the first surface faces outward from the substantially cylindrical object. A second surface of the base has at least portion of a friction material and rests on the surface of the substantially cylindrical object. The base is secured to the surface of the substantially cylindrical object by wrapping a fastening system around the base. In accordance with many embodiments, a sling is attached around the base and the substantially cylindrical object using a girth hitch to provide a hanging portion of the sling. In accordance with many embodiments, a carabiner is attached to the hanging portion of the sling. In accordance with a number of embodiments, a folded piece of material is attached to the carabiner.

### BRIEF DESCRIPTION OF THE DRAWINGS

FIG. 1 is an exploded topside view of an apparatus for providing a friction surface on a substantially cylindrical object in accordance with an embodiment of this invention.

FIG. 2 illustrates a bottom side view in accordance with an embodiment of this invention.

FIG. 3 illustrates a bottom side view in accordance with another embodiment of this invention.

FIG. 4 illustrates a view of an apparatus in accordance with an embodiment of this invention being affixed to a substantially cylindrical object.

FIG. 5 illustrates a view of an apparatus in accordance with an embodiment of this invention affixed to a substantially cylindrical object.

FIG. 6 illustrates a view of a nylon strap wrapped around an apparatus in accordance with an embodiment of this invention using a girth hitch.

FIG. 7 illustrates a flow diagram of a process for affixing a piece of fabric to a substantially cylindrical object using an apparatus providing a friction surface in accordance with an embodiment of this invention.

### DETAILED DISCLOSURE OF THE INVENTION

### Overview

Turning now to the drawings, some embodiments of an apparatus and a method for providing a friction surface on an object and more particularly, a substantially cylindrical object are disclosed. Although the following description describes embodiments for use with a substantially cylindrical object, the apparatus and methods in accordance with embodiments of this invention may be used with objects of other shapes including, but not limited to, square, rectangular, triangular, and the like. In accordance with embodiments of the invention, an apparatus includes a base made of bendable or foldable material. The base has a first and a second surface. At least the second surface has a friction material on at least a portion of the second surface in accordance with some embodiments. The base may be wrapped around a substantially cylindrical object. For purposes of this discussion, a substantially cylindrical object may be a pole, a tree branch, a rail, or any other object having a substantially circular circumference. In accordance with many embodiments, at least a portion of the first surface of the base is a friction material that prevents slippage of another object wrapped around the base.

The base is wrapped around and rested upon the surface of the substantially cylindrical object with the second surface resting on the surface in accordance with some embodiments. The portion of the second surface that is friction material has sufficient friction with the surface of the substantially cylindrical object to reduce slippage of the base when the base is secured to the surface of the substantially cylindrical object. For purposes of this discussion, a friction material is understood to be a material that has a surface that provides sufficient friction an opposing surface to reduce slippage when the two surfaces are in contact. In accordance with many embodiments, a fastening system secures the base in place on the surface of the substantially cylindrical object. In accordance various embodiments, the fastening system may be one or more loop and hook system(s), one or more belts with buckles and or loop, one or more elastic bands with hooks at opposing ends that wrap around the first surface of the base to secure the base to the substantially cylindrical object, or any other systems that couples to secure the base onto the surface of the substantially cylindrical object.

The apparatus may be used to provide a friction surface to prevent an object hung around the substantially cylindrical apparatus from slipping by providing a friction surface for the object to adhere to while hanging from the substantially cylindrical object. For example, the apparatus may minimize slippage of a fabric tied in a place around a metallic pole. In some embodiments, the apparatus is used to provide a fabric for use in a pole dancing routine where the pole is a substantially smooth metallic pole that provides little or no friction to allow a material tied around the pole to remain in place. In accordance with some of these embodiments, a method for affixing the fabric to the pole may be performed in the following manner. The base is wrapped around at least a portion of the substantially cylindrical object with the second surface of the base contacting the surface of the substantially cylindrical object. The fastener system is then applied to hold the base in place around the surface of the substantially cylindrical object. In some embodiments, a nylon sling may be wrapped around the base using a girth hitch to providing a hanging portion of the sling. In a number of embodiments, the hanging portion of the sling may form a loop. A carabiner may then be affixed to the hanging portion of the sling in a number of embodiments. A folded piece of fabric may then be inserted through the carabiner in several embodiments. The folded piece of material materials may then be used in a dance routine.

The following provides a detailed discussion some embodiments of the apparatus and methods for using the apparatus.

### Friction Apparatus

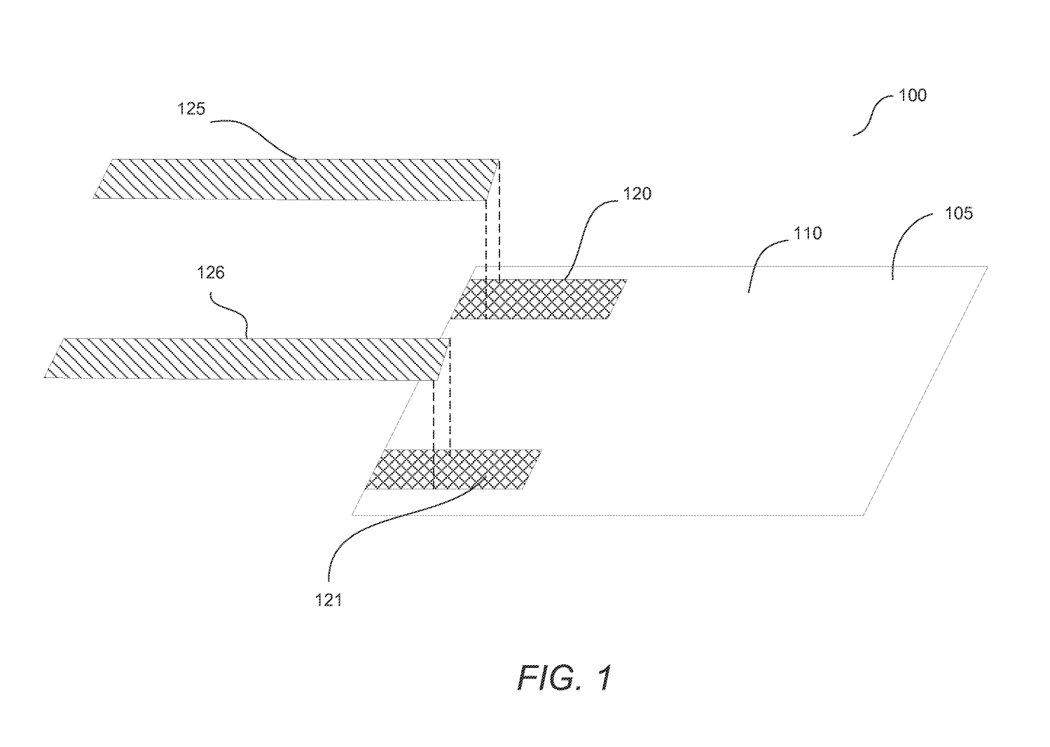

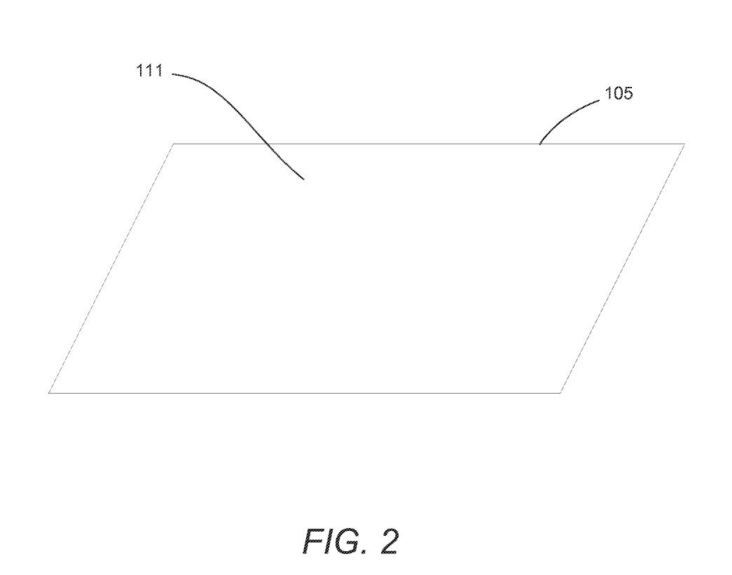

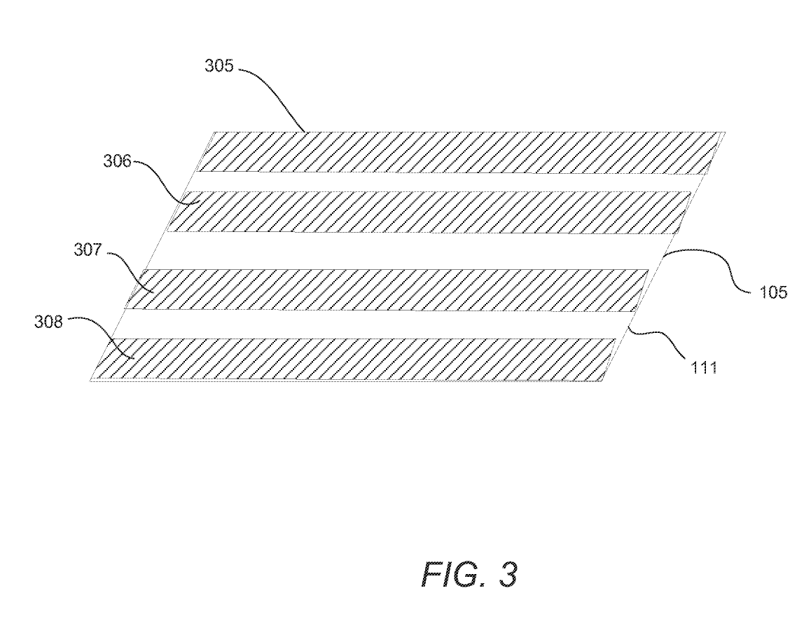

An apparatus that may be attached to a substantially cylindrical surface to reduce slippage of a secondary object attached to substantially cylindrical object over the apparatus in accordance with an embodiment of this invention is shown in FIG. 1. Apparatus 100 includes a base 105 and a fastening system. Base 105 includes a first surface 110 and a second surface 111 (FIG. 2 or FIG. 3). Base 105 is a rectangular shape with first and second ends on opposing sides along a longitudinal axis; and first and second sides on opposing sides along a latitudinal axis. One skilled in the art will recognize that base 105 may be other shapes without departing from the invention. In accordance with some embodiments, base 105 is made of foldable material that allows base 105 to be wrapped around a substantially cylindrical object. In accordance with some embodiments, the foldable material is a nylon or cloth material. Depending on the embodiment, the foldable material may be made of any easily malleable material. In accordance with a number of embodiments, the base is made of a friction material. The exact friction material may depend upon the type a material used to form the substantially cylindrical object. In a number of embodiments, the friction material may be, but is not limited to rubber and 40 neo with a steel finish.

In accordance with some embodiments, the longitudinal axis of base 105 is of sufficient length to wrap around the entirety of the substantially cylindrical object. In some of these embodiments, the length of the longitudinal axis is sufficient to allow the opposing ends of base 105 to overlap when base 105 is wrapped around a substantially cylindrical element. In accordance with some other embodiments, the length of base 105 along the longitudinal axis allows base 105 to wrap around only a portion of a substantially cylindrical object. One skilled in the art will recognize that the exact length needed will depend on many factors including, but not limited to, the circumference of the substantially cylindrical object, the desire and/or need for overlap of the ends of base 105, and the ability to secure the fastening system. For example, a metallic pole that is about 2 inches in circumference may require a base 105 that is 6 inches long along the longitudinal axis to wrap around the pole.

In the shown embodiment, the entirety of first surface 110 is a friction material. In accordance with some embodiments, the entire first surface 110 is a friction material affixed to base 105. In a number of these embodiments, the entire first surface 110 is an exposed surface of the friction material in base 105. In some embodiments, only a portion of first surface 110 is friction material. In accordance with some of these embodiments, the friction material is supplied by strips and/or patches of friction material over the first surface 110. The strips and/or patches may be affixed to first surface 110 by epoxy, stitches, heat pressing, or any other method that causes the strips to adhere to first surface 110. The friction material of first surface 110 contacts the surface of a secondary object wrapped around or in some other way applied to first surface 110 when base 105 is in place to reduce slippage of the secondary object.

A fastening system is used to hold base 105 in place when wrapped around at least a portion of the substantially cylindrical object. In accordance with some embodiments, the fastening system is used to hold base 105 in place until sufficient force may be applied to base 105 by the secondary object to secure base 105 in place. In the shown embodiment, the fastening system is two hook and loop systems. Any number of hook and loop systems may be used in other embodiments without departing from this embodiment. In the shown embodiment, the hook and loop system each include a first piece 120, 121 and second pieces 125,126. The first pieces are affixed to base 105 proximate a first end of base 105 where first piece 120 is affixed on a first side of first surface 110 of base 105 proximate the first end and first piece 121 is affixed on a second side of first surface 110 of base 105 opposite the first side proximate the first end of base 105. One skilled in the art will recognize that the first pieces may be affixed in any manner including, but not limited to, epoxying, stitching, and heat pressing. Second pieces 125,126, are mated to first pieces 120,121 such that first and second pieces couple when the pieces make contact. In the shown embodiment, the second pieces 125, 126 are of sufficient length that the piece may wrap around the entirety of base 105 when base 105 is wrapped around a substantially cylindrical object such that the first end second ends of each of the second pieces 125,126 overlap a portion of the respective first pieces 120,121 to allow each of the end of the second pieces to couple to a portion of the first pieces. One skilled in the art will recognize that although a hook and loops systems are used in the shown embodiment, any number of other fastening systems may be used without departing from these embodiments including, but not limited to, one or more belts with buckles, one or more belts with loops, one or more elastic straps with hooks on opposing ends, ratcheting systems, claps, and any other coupling system that can be used to hold base 105 in place.

A second surface of the apparatus contact the surface of a substantially cylindrical object when base 105 is wrapped around the substantially cylindrical object in accordance with different embodiments of the invention is shown in FIGS. 2 and 3. In the embodiment shown in FIG. 2, the entirety of second surface 111 is a friction material. In accordance with some embodiments, the entire second surface 111 is a friction material affixed to base 105. In a number of these embodiments, the entire second surface 111 is an exposed surface of the friction material in base 105. In some embodiments, only a portion of second surface 111 is friction material. In the embodiment shown in FIG. 3, the friction material is supplied by strips and/or patches 305-308 of friction material over the second surface 111. The strips and/or patches 305-308 may be affixed to first epoxy, stitches, heat pressing, or any other method that causes the strips to adhere to second surface 111. The friction material of second surface 111 contacts the surface of the substantially cylindrical object when base 105 is wrapped around or in some other way applied to base 105 to reduce slippage of the base 105.

### Application and Use of the Apparatus around a Substantially Cylindrical Object

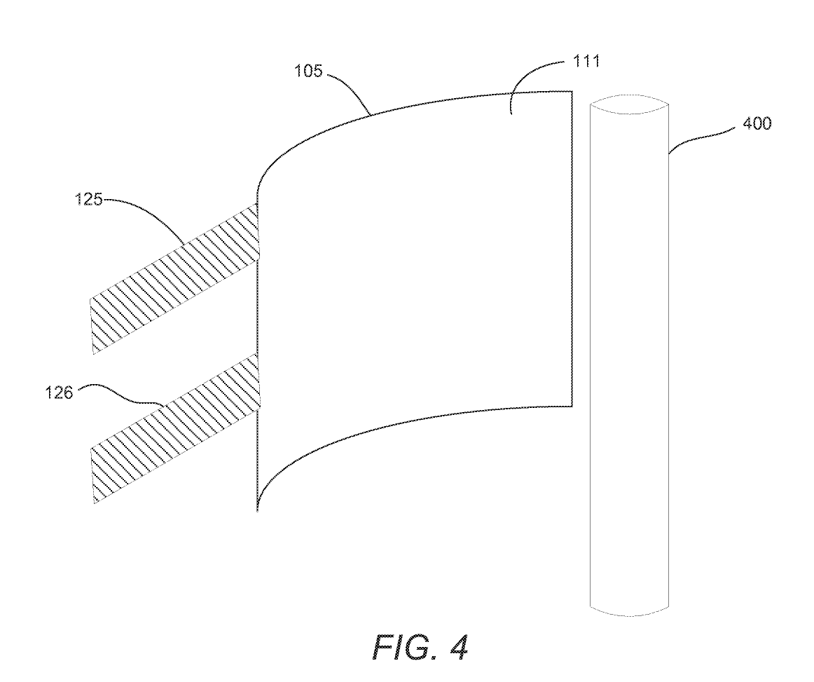

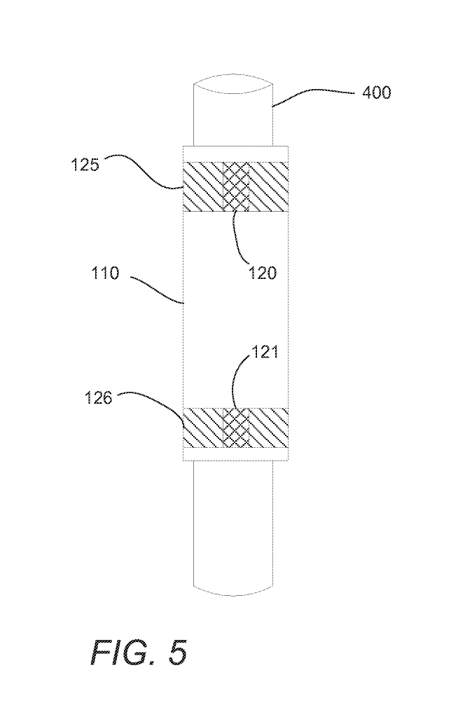

The application of apparatus 100 to a substantially cylindrical object in accordance with an embodiment of the invention is shown in FIGS. 4-6. In FIG. 4, base 105 of apparatus 100 is bent to conform to the curvature of substantially cylindrical object 400 with the second surface 111 facing the surface of the substantially cylindrical object 400. As shown, the second ends of second pieces 125,126 of the hook and loop systems extend out from base 105. In FIG. 5, base 105 is wrapped around the surface of the side of the substantially cylindrical object 400 with the second surface 111 of base 105 in contact with the surface of the substantially cylindrical object 400 and the first surface 110 facing out. The two ends of each of the second pieces of the hook and loop systems are mated to a portion of the respective first pieces 120,121 to secure the second pieces in place around base 105. In accordance with some embodiments, the second pieces are tightly fastened such that the hook and loop systems apply sufficient pressure to keep base 105 in place on the surface of the substantially cylindrical object 400. One skilled in the art will note that although base 105 is shown as wrapping completely around the surface of the substantially cylindrical object 400 in the shown embodiment, the base 105 may wrap around a portion of the circumference of the substantially cylindrical object 400 in other embodiments.

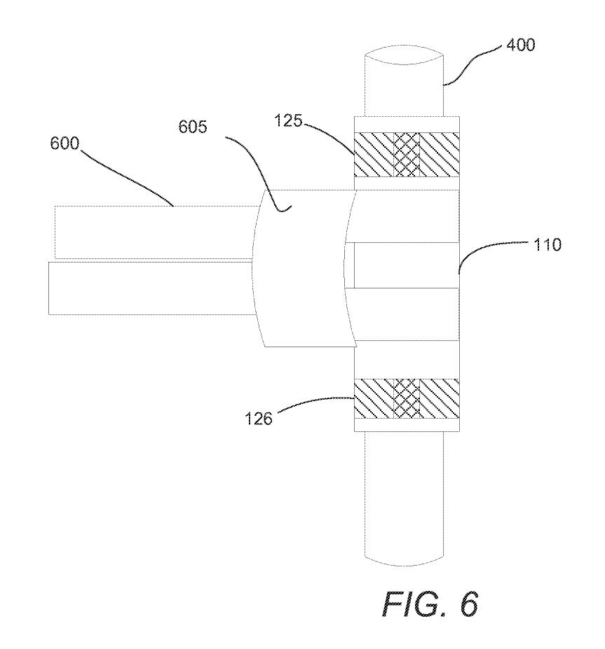

An example of a secondary object affixed to a substantially cylindrical object using a friction apparatus in accordance with embodiments of this invention is shown in FIG. 6. In FIG. 6, apparatus 100 is affixed to substantially cylindrical object 400 as shown in FIG. 5. Nylon sling 600 is then wrapped around the first surface 110 of base 105 such that a portion of nylon sling 600 is in contact with the first surface 110 of base 110 and is held in place around first surface 110 using a girth hitch 605. As shown in FIG. 6, first surface 110 provides a sufficient amount of a friction surface to allow the secondary object (nylon sling 600) to contact the friction surface which supplies sufficient friction to reduce the slippage of the secondary object in accordance with some embodiments of the invention. Furthermore, the secondary object applies force to base 105 to hold base 105 in place around substantially cylindrical object 400 in accordance with some embodiments of the invention. One skilled in the art will recognize that although a nylon sling is shown wrapped around base 105 in the shown embodiment, other secondary objects affixed in other manners to base 105 may be used in accordance with other embodiments.

### Methods of Attaching a Piece of Fabric to Pole for Use in a Dance Routine

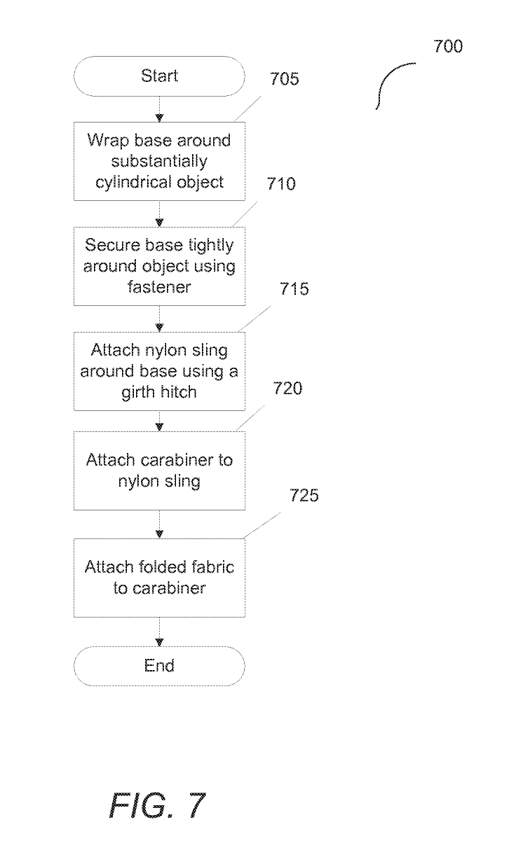

A flow diagram of a process for attaching a piece of fabric to a pole (substantially cylindrical object) in accordance with embodiment of this invention is shown in FIG. 7. In process 700, base 105 of friction apparatus 100 is wrapped around the circumference of the pole (substantially cylindrical object) (705) such as by the process described above with respect to FIGS. 4 and 5. A fastening system then secures the base tightly to the pole (substantially cylindrical object) (710) such as in the manner described with respect to FIG. 5. A nylon string is then attached around the base affixed to the pole (substantially cylindrical object) using a girth hitch (715) to provide a hanging portion of the sling (loop). A carabiner is affixed to the hanging portion (loop) of the nylon sling (720). A folded fabric is then attached to the carabiner (720). In some embodiments, the fabric may be directly threaded through carabiner. In other embodiments, the folded fabric may be looped or threaded through a loop or ring and the loop or ring is affixed to carabiner. The fabric may then be used for a dance routine.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An apparatus for providing a friction surface for on an object, comprising:
a base made of bendable material having a first surface, a second surface, a first end, and a second end where the first end and the second end are on opposite sides of the base along a longitudinal axis of the base and the base is of a sufficient length to wrap around at least a portion of a surface of an object;
a portion of the second surface being a friction material that holds the base in place when the base is affixed to the object with the second surface in contract with the surface of the object; and
a fastening system that engages with the base to hold the base in place in response to the base being wrapped around at least a portion of the surface of the object.

2. The apparatus of claim 1 further comprising:
a portion of the first surface being a friction material to provide a friction surface to hold a secondary object wrapped around the base when the base is wrapped around the surface of the object.

3. The apparatus of claim 1 wherein the portion of the second surface that is a friction material comprises:
a plurality of strips of friction material affixed to the second surface.

4. The apparatus of claim 3 wherein the plurality of strips of friction material cover substantially a majority of the second surface.

5. The apparatus of claim 1 wherein the fastening system comprises:
a first piece of a hook and loop system having a first end and a second end affixed to the first surface of the base on the first end of the base with the first end of the first piece being proximate to the first end of the base; and
a second piece of the hook and loop system that is mated to the first piece having a first end that connects to the second end of the first piece as the second piece wraps around the base when the base is wrapped around the surface of the object, and a second end that affixes to the first end of the first as the second piece wraps around the base when the base is wrapped around the surface of the object.

6. The apparatus of claim 1 wherein the fastening system comprises:
a plurality of hook and loop systems wherein each of the plurality of hook and loop systems comprise:
a first piece of a hook and loop system having a first end and a second end affixed to the first surface of the base on the first end of the base with the first end of the first piece being proximate to the first end of the base; and
a second piece of the hook and loop system that is mated to the first piece having a first end that connects to the second end of the first piece as the second piece wraps around the base when the base is wrapped around the surface of the object, and a second end that affixes to the first end of the first as the second piece wraps around the base when the base is wrapped around the surface of the object.

7. The apparatus of claim 6 wherein the plurality of hook and loop systems include a first hook and loop system and a second hook and loop system wherein the first piece of the first hook and loop system is affixed to the first surface of the base proximate a first side of the first end of the base; and the first piece of the second hook and loop system is affixed to the first surface of the base proximate a second side of the first end of the base opposite the first side of the base.

8. The apparatus of claim 1 wherein the fastening system includes at least one selected from a group consisting of:
a belt with a buckle hole system that wraps around the first surface of the base;
a belt with a loop system in which a first end of the belt threads through a plurality of loops as the belt wraps around the first surface of the base; and
an elastic strap with hooks on opposing ends where the hooks are couple to hold the strap in place when the elastic strap wraps around the first surface of the base.

9. The apparatus of claim 1 wherein the base is made of a friction material such that the first surface and the second surface are the friction material.

10. The apparatus of claim 9 wherein the friction material of the base is rubber.

11. The apparatus of claim 1 wherein the object is a substantially cylindrical object.

12. The apparatus of claim 11 wherein the substantially cylindrical object is a metallic pole.

13. A method for affixing a base to provide a friction material on a surface of a substantially cylindrical object comprising:
wrapping a base around a surface of a substantially cylindrical surface with a first surface having a friction material on at least a portion of the first surface facing outward from the substantially cylindrical object and a portion of a second surface of the base having a friction material and resting on the surface of the substantially cylindrical object; and
securing the base to the surface of the substantially cylindrical object by wrapping a fastening system around the base.

14. The method of claim 13 further comprising:
attaching a sling around the base and the substantially cylindrical object using a girth hitch to provide a hanging portion of the sling.

15. The method of claim 14 further comprising:
attaching a carabiner to the hanging portion of the sling.

16. The method of claim 15 further comprising:
attaching a folded piece of material to the carabiner.
